(19) United States
(12) Patent Application Publication
(10) Pub. No.: US 2026/0249698 A1
(43) Pub. Date: Aug. 27, 2026

(54) ADAPTIVE ANTI-MOTION-SICK METHOD AND ADAPTIVE ANTI-MOTION-SICK SYSTEM USING THE SAME

(71) Applicant: INDUSTRIAL TECHNOLOGY RESEARCH INSTITUTE, Hsinchu (TW)

(72) Inventors: Hong-Ming DAI, Butai Town (TW); Ya-Rou HSU, Tongxiao Township (TW); Chien-Ju LEE, Taoyuan City (TW); Chia-Hsun TU, Taipei City (TW); Yu-Hsiang TSAI, Zhubei City (TW)

(73) Assignee: INDUSTRIAL TECHNOLOGY RESEARCH INSTITUTE, Hsinchu (TW)

(21) Appl. No.: 19/266,421

(22) Filed: Jul. 11, 2025

(30) Foreign Application Priority Data
Feb. 25, 2025 (TW) 114106968

(51) Int. Cl. B60K 35/81; B60K 35/10; B60K 35/29; B60R 16/037; G06F 3/01

(52) U.S. Cl. CPC B60K 35/81; B60K 35/10; B60K 35/29; B60R 16/037; G06F 3/015

(57) ABSTRACT

An adaptive anti-motion-sick method and an adaptive anti-motion-sick system using the same are provided. The adaptive anti-motion-sick method could include the following steps. A real-time information is obtained. The real-time information could include a user image of a user, a traffic information, an information format of a display unit, or a combination thereof. An anti-motion-sick display setting information is inferred by an inference module according to the real-time information. The anti-motion-sick display setting information is an anti-motion-sick adjustment parameter, an anti-motion-sick method, or a combination thereof. The display unit is controlled according to the anti-motion-sick display setting information.

This application claims the benefit of Taiwan application Serial No. 114106968, filed Feb. 25, 2025, the disclosure of which is incorporated by reference herein in its entirety.

### TECHNICAL FIELD

The present disclosure relates to an adaptive anti-motion-sick method and an adaptive anti-motion-sick system using the same.

### BACKGROUND

With the increasing popularity of electric vehicles, the audiovisual equipment in vehicles has also been upgraded. In addition to audiovisual and navigation functions, there is now a growing demand for enhancing passenger comfort. Therefore, to reduce or prevent motion sickness experienced by passengers, the industry has been actively developing various technologies in recent years in the hope of mitigating or eliminating motion sickness.

### SUMMARY

According to one embodiment, an adaptive anti-motion-sick method is provided. The adaptive anti-motion-sick method comprises: obtaining a real-time information, wherein the real-time information is a user image of a user, a traffic information, a display information format of a display unit, or a combination thereof; inferring, by an inference module, an anti-motion-sick display setting information according to the real-time information, wherein the anti-motion-sick display setting information is an anti-motion-sick adjustment parameter, an anti-motion-sick method, or a combination thereof; and controlling the display unit according to the anti-motion-sick display setting information.

According to another embodiment, an adaptive anti-motion-sick system is provided. The adaptive anti-motion-sick system comprises a display unit, a real-time information acquisition module, an inference module and an anti-motion-sick module. The real-time information acquisition module is used for obtaining a real-time information. The real-time information comprises a user image of a user, a traffic information, a display information format of the display unit, or a combination thereof. The inference module is for inferring an anti-motion-sick display setting information according to the real-time information. The anti-motion-sick display setting information comprises an anti-motion-sick adjustment parameter, an anti-motion-sick method, or a combination thereof. The anti-motion-sick module is used for controlling the display unit according to the anti-motion-sick display setting information.

### BRIEF DESCRIPTION OF THE DRAWINGS

FIG. 1 illustrates a schematic diagram of an adaptive anti-motion-sick system according to an embodiment of this disclosure.

FIG. 2 illustrates a flowchart of an adaptive anti-motion-sick method according to an embodiment of this disclosure.

FIGS. 3A to 3D illustrate various examples of the anti-motion-sick method.

FIG. 4 illustrates a schematic diagram of an adaptive anti-motion-sick system according to another embodiment of the present disclosure.

FIG. 5 illustrates a flowchart of an adaptive anti-motion-sick method according to another embodiment of the present disclosure.

FIG. 6 illustrates a schematic diagram of an adaptive anti-motion-sick system according to another embodiment of the present disclosure.

FIG. 7 illustrates a flowchart of an adaptive anti-motion-sick method according to another embodiment of the present disclosure.

FIG. 8 illustrates a schematic diagram of an adaptive anti-motion-sick system according to another embodiment of the present disclosure.

FIG. 9 illustrates a flowchart of an adaptive anti-motion-sick method according to another embodiment of this disclosure.

FIG. 10 illustrates a schematic diagram of an adaptive anti-motion-sick system according to another embodiment of the present disclosure.

FIG. 11 illustrates a flowchart of an adaptive anti-motion-sick method according to another embodiment of the present disclosure.

FIG. 12 illustrates a schematic diagram of an adaptive anti-motion-sick system according to another embodiment of the present disclosure.

FIG. 13 illustrates a flowchart of an adaptive anti-motion-sick method according to another embodiment of the present disclosure.

FIG. 14 illustrates a schematic diagram of an adaptive anti-motion-sick system of another embodiment of the present disclosure.

FIG. 15 illustrates a flowchart of an adaptive anti-motion-sick method according to another embodiment of the present disclosure.

FIG. 16 illustrates a schematic diagram of an adaptive anti-motion-sick system according to another embodiment of the present disclosure.

FIG. 17 illustrates a flowchart of an adaptive anti-motion-sick method according to another embodiment of the present disclosure.

FIG. 18 illustrates a schematic diagram of an adaptive anti-motion-sick system of another embodiment of the present disclosure.

FIG. 19 illustrates a flowchart of an adaptive anti-motion-sick method according to another embodiment of the present disclosure.

FIG. 20 illustrates a display method of a display information and a reference pattern according to an embodiment of the present disclosure.

In the following detailed description, for purposes of explanation, numerous details are set forth in order to provide a thorough understanding of the disclosed embodiments. It will be apparent that one or more embodiments may be practiced without these details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

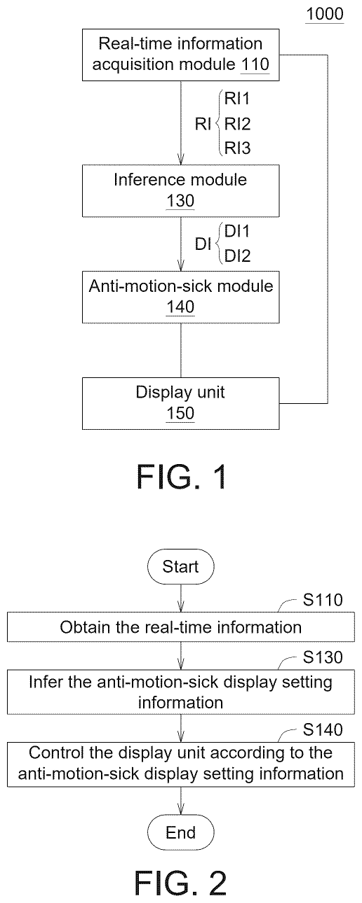

Please refer to FIG. 1, which illustrates a schematic diagram of an adaptive anti-motion-sick system 1000 according to an embodiment of the present disclosure. In this embodiment, the adaptive anti-motion-sick system 1000 is used to prevent or reduce the motion sickness occurred in the user traveling in a vehicle. The adaptive anti-motion-sick system 1000 includes, for example, a real-time information acquisition module 110, an inference module 130, an anti-motion-sick module 140, and a display unit 150.

The real-time information acquisition module 110 is used to obtain various types of information. The inference module 130 is used to perform an artificial intelligence inference process. The display unit 150 is used to display various types of information. The anti-motion-sick module 140 is used to control the display unit 150 to reduce or prevent the motion sickness. The real-time information acquisition module 110, the inference module 130, and/or the anti-motion-sick module 140 may be a circuit, a circuit board, a storage device storing program code, or a chip. The chip may include a central processing unit (CPU), or other programmable general-purpose or special-purpose micro control units (MCU), microprocessors, digital signal processors (DSP), programmable controllers, application-specific integrated circuits (ASIC), graphics processing units (GPU), image signal processors (ISP), image processing units (IPU), arithmetic logic units (ALU), complex programmable logic devices (CPLD), field-programmable gate arrays (FPGA), or other similar components or combinations of the aforementioned components. The display unit 150 may be a display panel (including transparent or non-transparent display devices) or a light strip.

In this disclosure, through the artificial intelligence technology, the inference module 130 could infer an anti-motion-sick display setting information DI according to a real-time information RI obtained by the real-time information acquisition module 110. The anti-motion-sick module 140 could control the display unit 150 according to the anti-motion-sick display setting information DI to prevent or reduce the motion sickness occurred in the user traveling in a vehicle. The following sections detail the adaptive anti-motion-sick method in conjunction with flowcharts.

Please refer to FIG. 2, which illustrates a flowchart of the adaptive anti-motion-sick method according to an embodiment of the present disclosure. The adaptive anti-motion-sick method includes, for example, steps S110, S130, and S140.

In the step S110, as shown in the FIG. 1, the real-time information acquisition module 110 obtains a real-time information RI. The real-time information RI includes, for example, a user image RI1, a traffic information RI2, a display information format RI3 of the display unit 150, or a combination thereof. The user image RI1 is, for example, an image captured in real-time of the user inside the vehicle. The traffic information RI2 is, for example, a vibration condition of the vehicle. The display information format RI3 is, for example, the type of information displayed on the display unit 150 at that time.

Next, in the step S130, as shown in the FIG. 1, the inference module 130 infers an anti-motion-sick display setting information DI according to the real-time information RI. The anti-motion-sick display setting information DI includes, for example, an anti-motion-sick adjustment parameter DI1, an anti-motion-sick method DI2, or a combination thereof. The anti-motion-sick adjustment parameter DI1 includes, for example, a color compensation amplitude or a position compensation amplitude of the display information, or a combination thereof. These adjustments to the display information help mitigate or prevent user motion sickness.

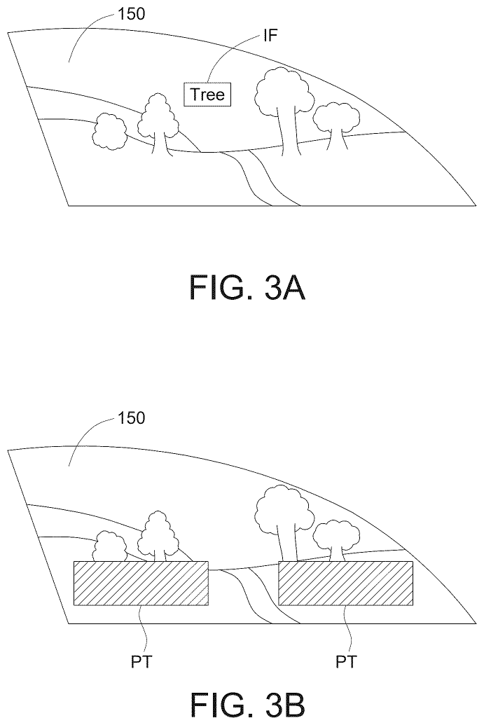

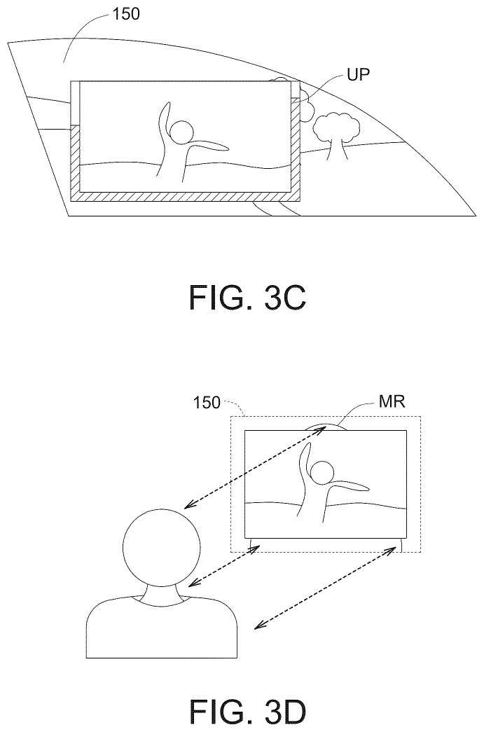

The anti-motion-sick method DI2 includes various display techniques that help alleviate or prevent user motion sickness. Please refer to FIGS. 3A to 3D, which illustrate various examples of the anti-motion-sick method DI2.

As shown in the FIG. 3A, the display unit 150 is, for example, a transparent display panel on a vehicle window. In the anti-motion-sick method DI2 of the FIG. 3A, the display unit 150 presents a display information IF. The display information IF is, for example, a text introducing scenery or buildings outside the window. The display information IF is, for example, positioned according to a gaze intersection of the user, an object movement direction, a movement speed, etc. When the vehicle shakes, the displayed display information IF may also shake accordingly. These implementations are illustrative examples and do not limit the scope of this disclosure. When the brain's visual perception matches the shaking, it helps the brain adjust its sense of balance, reducing the user's motion sickness when looking at the vehicle window.

As shown in the FIG. 3B, the display unit 150 is, for example, the transparent display panel on the vehicle window. In the anti-motion-sick method DI2 of the FIG. 3B, the display unit 150 presents a reference pattern PT. The reference pattern PT is, for example a rectangle, a circle, a triangle, or any geometric shape. The reference pattern PT is positioned according to the gaze intersection of the user, the object movement direction, the movement speed, etc. When the vehicle shakes, the displayed reference pattern PT may also shake accordingly. These implementations are illustrative examples and do not limit the scope of this disclosure. When the brain's visual perception matches the shaking, it helps the brain adjust its sense of balance, reducing the motion sickness occurred in the user when looking at the vehicle window.

As shown in the FIG. 3C, the display unit 150 is, for example, the transparent display panel on the vehicle window. In the anti-motion-sick method DI2 of the FIG. 3C, the display unit 150 presents a dynamic U-tube UP. The dynamic U-tube UP is, for example, positioned at the edge of a movie screen, photo, or advertisement display. When the vehicle shakes, the displayed U-tube UP could shake accordingly to the left or right. These implementations are illustrative examples and do not limit the scope of this disclosure. When the brain's visual perception matches the shaking, it helps the brain adjust its sense of balance, reducing the motion sickness occurred in the user when looking at the vehicle window.

As shown in the FIG. 3D, the display unit 150 is, for example, a display panel presenting a movie, a photo, or an advertisement. The display unit 150 could display a mirrored image MR of the user outside the movie, the photo, or the advertisement. When the vehicle shakes, the mirrored image MR could also shake accordingly. These implementations are illustrative examples and do not limit the scope of this disclosure. When the brain's visual perception matches the shaking, it helps the brain adjust its sense of balance, reducing the motion sickness occurred in the user when looking at the vehicle window.

After obtaining the anti-motion-sick display setting information DI (the anti-motion-sick adjustment parameter DI1 and/or the anti-motion-sick method DI2), in the step S140, the anti-motion-sick module 140 controls the display unit 150 according to the anti-motion-sick display setting information DI to prevent or reduce motion sickness occurred in the user traveling in a vehicle.

Based on the above embodiments, the adaptive anti-motion-sick system 1000 could use the artificial intelligence technology to infer the anti-motion-sick display setting information DI according to the real-time information RI to prevent or reduce motion sickness occurred in the user traveling in a vehicle.

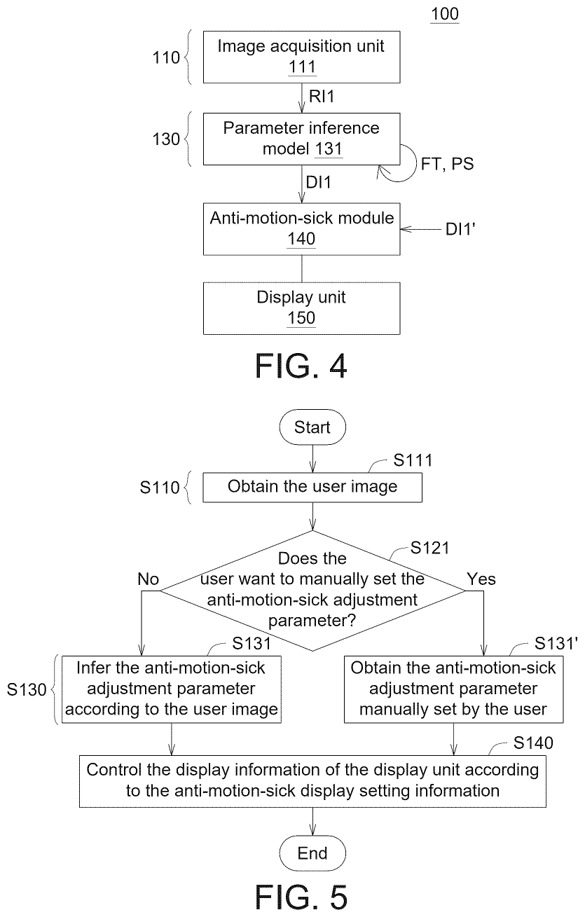

Please refer to FIG. 4, which illustrates a schematic diagram of the adaptive anti-motion-sick system 100 according to another embodiment of the present disclosure. In the adaptive anti-motion-sick system 100 shown in the FIG. 4, the real-time information acquisition module 110 includes, for example, an image acquisition unit 111. The inference module 130 includes, for example, a parameter inference model 131. The image acquisition unit 111 is used to acquire images, and the parameter inference model 131 is used to infer parameters. The functions of the anti-motion-sick module 140 and the display unit 150 are as described above and will not be repeated here. The following describes the operation of each component in detail with reference to the flowchart.

Please refer to FIG. 5, which illustrates a flowchart of an adaptive anti-motion-sick method according to another embodiment of the present disclosure. The adaptive anti-motion-sick method shown in the FIG. 5 includes steps S110, S121, S130, and S140. The step S110 includes step S111, and the step S130 includes steps S131 and S131′.

In step the S111, as shown in the FIG. 4, the image acquisition unit 111 obtains the user image RI1. The image acquisition unit 111 is, for example, a camera or a camcorder. The user image RI1 is, for example, a static or dynamic image of the user in a vehicle.

Next, in the step S121, as shown in the FIG. 4, the anti-motion-sick module 140 determines whether the user wants to manually set the anti-motion-sick adjustment parameter DI1. If the user wants to manually set the anti-motion-sick adjustment parameter DI1, the process proceeds to the step S131′; if the user does not want to manually set the anti-motion-sick adjustment parameter DI1, the process proceeds to the step S131. In this step, a user interface may be provided for the user to select options such as “manual” or “automatic” to determine whether the user wants to manually set the anti-motion-sick adjustment parameter DI1.

In the step S131, as shown in the FIG. 4, the parameter inference model 131 infers the anti-motion-sick adjustment parameter DI1 according to the user image RI1. Motion sickness, for example, may be caused by inconsistencies in sensory information such as vision, the inner ear, and touch. Different users have different sensitivities to vehicle motion. Research indicates that motion sickness is most pronounced in children aged 9 to 10 years, and females are more prone to dizziness when traveling in vehicles than males. Users in poorer physiological states are also more likely to experience dizziness.

In this step, as shown in the FIG. 4, the parameter inference model 131 may first infer a user characteristic FT and a physiological state PS according to the user image RI1, and then infer the anti-motion-sick adjustment parameter DI1 according to the user characteristic FT and the physiological state PS. Alternatively, the parameter inference model 131 may directly infer the anti-motion-sick adjustment parameter DI1 according to the user image RI1.

The user characteristic FT includes, for example, factors such as age, gender, or body type. As mentioned above, these factors may affect the degree of dizziness experienced by the user. The physiological state PS includes, for example, dizziness status or health status. As described above, the physiological state PS may influence the user's susceptibility to dizziness. The dizziness status may be classified into levels 0 to 5. Level 0 is “No symptoms” (no motion sickness symptoms, and feeling good). Level 1 is “Mild symptoms” (slight discomfort, and not affecting normal activities, such as slight dizziness or mild stomach discomfort). Level 2 is “Moderate symptoms” (symptoms such as headaches, nausea, or dizziness appear but are still tolerable, allowing partial activities). Level 3 is “Severe symptoms” (significant motion sickness symptoms such as severe nausea, dizziness, or physical discomfort, requiring activity cessation or rest). Level 4 is “Severe dizziness” (extreme discomfort, symptoms are very severe, unable to continue activities, possibly accompanied by vomiting, loss of balance, etc.). Level 5 is “Extreme dizziness” (requires immediate cessation of activity and may require medical intervention, severe motion sickness, unable to return to normal activities). The dizziness status classification is only an example for illustration, and the technology of the present disclosure is not limited to this classification.

The physiological state PS may be classified into levels 1 to 9. Level 1 is “Very healthy.” Level 2 is “Healthy.” Level 3 is “Maintaining good condition.” Level 4 is “Pre-weakness stage.” Level 5 is “Mild weakness.” Level 6 is “Moderate weakness.” Level 7 is “Severe weakness.” Level 8 is “Long-term bedridden.” Level 9 is “End of life.” The classification of physiological state PS is only for illustrative purposes, and the technology of the present disclosure is not limited to this classification.

In this embodiment, the anti-motion-sick adjustment parameter DI1 inferred by the parameter inference model 131 includes, for example, color, X-axis compensation amplitude, Y-axis compensation amplitude, Z-axis compensation amplitude, or a combination thereof.

In the step S131′, as shown in the FIG. 4, the anti-motion-sick module 140 obtains the anti-motion-sick adjustment parameter DI1′ manually set by the user. The anti-motion-sick adjustment parameter DI1′ includes, for example, color, X-axis compensation amplitude, Y-axis compensation amplitude, Z-axis compensation amplitude, or a combination thereof.

Then, in the step S140, as shown in the FIG. 4, the anti-motion-sick module 140 controls the display information of the display unit 150 according to the anti-motion-sick display setting information DI, including the anti-motion-sick adjustment parameters DI1 and DI1′, to reduce or prevent motion sickness occurred in the user traveling in a vehicle.

According to the embodiments shown in the FIGS. 4 and 5, for different user images RI1, the artificial intelligence technology could be used to adaptively infer suitable anti-motion-sick adjustment parameters DI1 to adaptively control the display content of the display unit 150, thereby reducing or preventing the motion sickness occurred in the user.

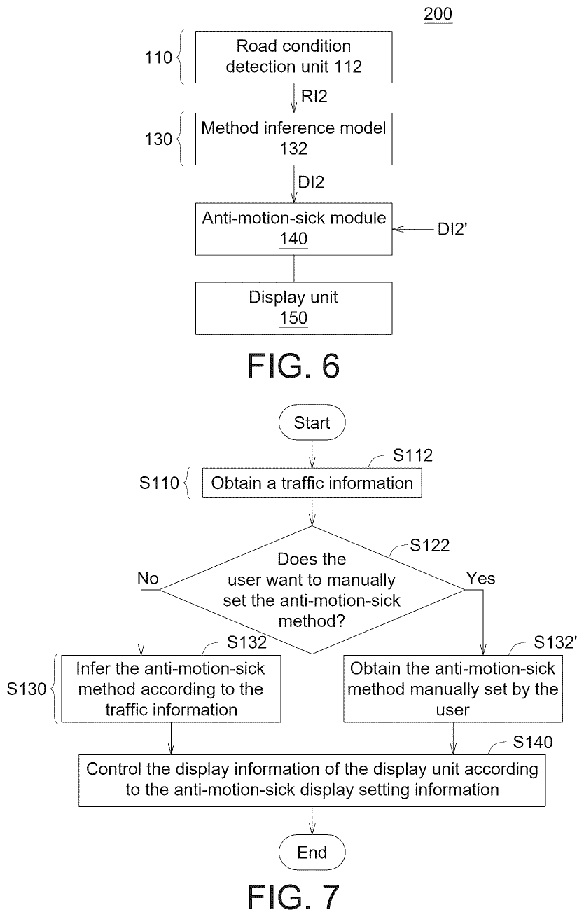

Please refer to FIG. 6, which illustrates a schematic diagram of an adaptive anti-motion-sick system 200 according to another embodiment of the present disclosure. In the adaptive anti-motion-sick system 200 of the FIG. 6, the real-time information acquisition module 110 includes, for example, a road condition detection unit 112. The inference module 130 includes, for example, a method inference model 132. The road condition detection unit 112 is used to detect road conditions. The method inference model 132 is used to infer methods. The functions of the anti-motion-sick module 140 and the display unit 150 have been described above and will not be repeated here. The following flowchart provides a detailed description of the operation of each component.

Please refer to FIG. 7, which illustrates a flowchart of an adaptive anti-motion-sick method according to another embodiment of the present disclosure. The adaptive anti-motion-sick method in FIG. 7 includes steps S110, S122, S130, and S140. The step S110 includes step S112, and the step S130 includes steps S132 and S132′.

In the step S112, as shown in the FIG. 6, the road condition detection unit 112 obtains the traffic information RI2 of the vehicle. The road condition detection unit 112 is, for example, a gyroscope, an accelerometer, or an inertial measurement unit (IMU). The traffic information RI2 is, for example, the vibration frequency at a single time point or a vibration curve over a period of time.

Next, in the step S122, as shown in the FIG. 6, the anti-motion-sick module 140 determines whether the user wants to manually set the anti-motion-sick method DI2. If the user wants to manually set the anti-motion-sick method DI2, the process proceeds to the step S132′; if the user does not want to manually set the anti-motion-sick method DI2, the process proceeds to the step S132. In this step, a user interface may be provided to allow the user to select options such as “manual” or “automatic” to determine whether the user wants to manually set the anti-motion-sick method DI2.

In the step S132, as shown in the FIG. 6, the method inference model 132 infers the anti-motion-sick method DI2 according to the traffic information RI2. In one embodiment, if the vibration is high-frequency, the vibration compensation method for the display information IF in FIG. 3A may be adopted; if the vibration is a left-right sway, the vibration compensation method for the dynamic U-tube UP in the FIG. 3C may be adopted. In this embodiment, the method inference model 132 could infer the appropriate anti-motion-sick method DI2 according to the traffic information RI2. These embodiments are provided for illustration only, and this disclosure is not limited thereto.

In the step S132′, as shown in the FIG. 6, the anti-motion-sick module 140 obtains the anti-motion-sick method DI2 manually set by the user.

Then, in the step S140, as shown in the FIG. 6, the anti-motion-sick module 140 controls the display information of the display unit 150 according to the anti-motion-sick method DI2 and DI2′ of the anti-motion-sick display setting information DI, to prevent or reduce the motion sickness occurred in the user traveling in the vehicle.

According to the embodiments in the FIGS. 6 to 7, the artificial intelligence technology could be used to adaptively infer the suitable anti-motion-sick method DI2 according to according to the traffic information RI2, thereby adaptively controlling the display content of the display unit 150 to reduce or prevent motion sickness occurred in the user.

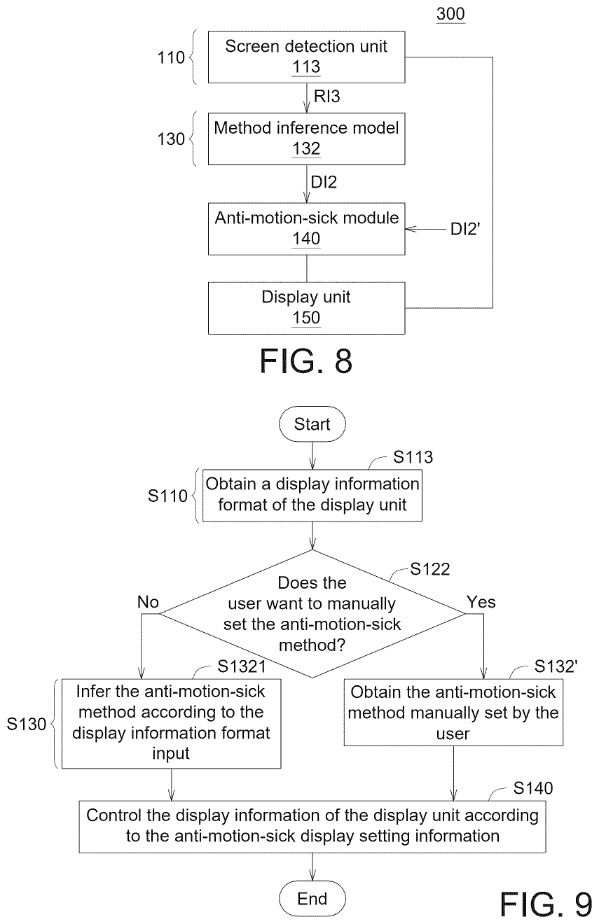

Please refer to FIG. 8, which illustrates a schematic diagram of an adaptive anti-motion-sick system 300 according to another embodiment of the present disclosure. In the adaptive anti-motion-sick system 300 of the FIG. 8, the real-time information acquisition module 110 includes, for example, a screen detection unit 113. The inference module 130 includes, for example, the method inference model 132. The screen detection unit 113 is used to detect screens. The method inference model 132 is used to infer methods. The functions of the anti-motion-sick module 140 and the display unit 150 have been described above and will not be repeated here. The following flowchart provides a detailed description of the operation of each component.

Please refer to FIG. 9, which illustrates a flowchart of an adaptive anti-motion-sick method according to another embodiment of the present disclosure. The adaptive anti-motion-sick method in the FIG. 9 includes steps S110, S122, S130, and S140. The step S110 includes step S113. The step S130 includes steps S1321 and S132′.

In the step S113, as shown in the FIG. 8, the screen detection unit 113 obtains a display information format RI3 of the display unit 150. The screen detection unit 113 is, for example, a circuit, a chip, a circuit board, or a storage device storing program code. The display information format RI3 of the display unit 150 is, for example, the proportion of display content in the information screen. For example, the proportion is relatively low for text or markers, whereas it is relatively high for movies or advertisements. These embodiments are provided for illustration only, and this disclosure is not limited thereto.

Next, in the step S122, as shown in the FIG. 8, the anti-motion-sick module 140 determines whether the user wants to manually set the anti-motion-sick method DI2. If the user wants to manually set the anti-motion-sick method DI2, the process proceeds to step S132′; if the user does not want to manually set the anti-motion-sick method DI2, the process proceeds to the step S1321. In this step, a user interface may be provided to allow the user to select options such as “manual” or “automatic” to determine whether the user wants to manually set the anti-motion-sick method DI2.

In the step S1321, as shown in the FIG. 8, the method inference model 132 infers the anti-motion-sick method DI2 according to the display information format input RI3. In one embodiment, if the information proportion is small, the vibration compensation method of the reference pattern PT in the FIG. 3B may be adopted; if the information proportion is large, the vibration compensation method of the dynamic U-tube UP in the FIG. 3C may be adopted. In this embodiment, the method inference model 132 could infer an appropriate anti-motion-sick method DI2 according to the display information format RI3. These embodiments are provided for illustration only, and this disclosure is not limited thereto.

In the step S132′, as shown in the FIG. 8, the anti-motion-sick module 140 obtains the anti-motion-sick method DI2′ manually set by the user.

Then, in the step S140, as shown in the FIG. 8, the anti-motion-sick module 140 controls the display information of the display unit 150 according to the anti-motion-sick display setting information DI, including the anti-motion-sick method DI2 and DI2′, to prevent or reduce the motion sickness occurred in the user traveling in the vehicle.

According to the embodiments in the FIGS. 8 to 9, the artificial intelligence technology could be used to adaptively infer the suitable anti-motion-sick method DI2 according to the display information formats RI3, thereby adaptively controlling the display content of the display unit 150 to reduce or prevent the motion sickness occurred in the user.

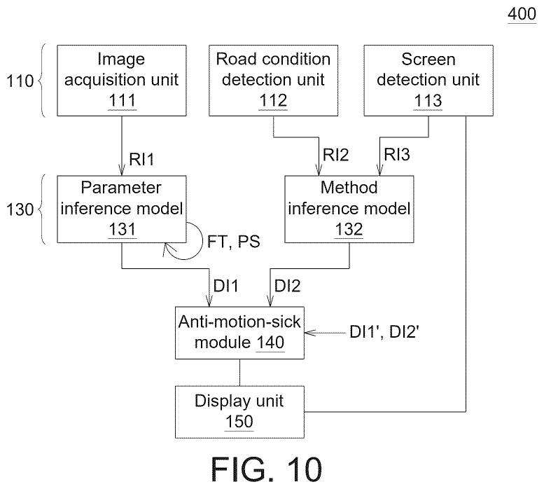

Please refer to FIG. 10, which illustrates a schematic diagram of an adaptive anti-motion-sick system 400 according to another embodiment of the present disclosure. In the adaptive anti-motion-sick system 400 of the FIG. 10, the real-time information acquisition module 110 includes, for example, the image acquisition unit 111, the road condition detection unit 112, and the screen detection unit 113. The inference module 130 includes, for example, the parameter inference model 131 and the method inference model 132. The following description, in conjunction with the flowchart, details the operation of each component.

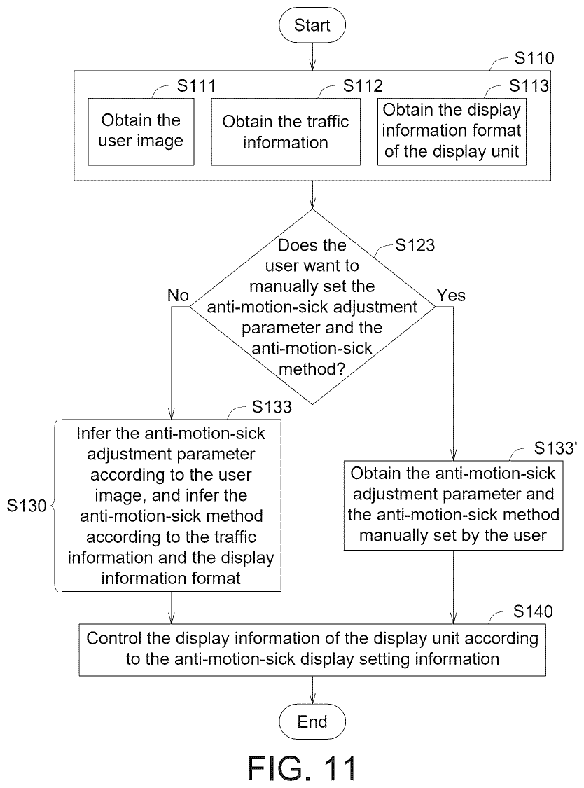

Please refer to FIG. 11, which illustrates a flowchart of an adaptive anti-motion-sick method according to another embodiment of the present disclosure. The adaptive anti-motion-sick method of the FIG. 11 includes steps S110, S123, S130, and S140. The step S110 includes steps S111, S112, and S113. The step S130 includes steps S133 and S133′.

In the step S111, as shown in the FIG. 10, the image acquisition unit 111 obtains the user image RI1. In the step S112, as shown in the FIG. 10, the road condition detection unit 112 obtains the traffic information RI2. In the step S113, as shown in the FIG. 10, the screen detection unit 113 obtains the display information format RI3 of the display unit 150. The steps S111 to S113 may be executed simultaneously or in a predetermined order.

Next, in the step S123, as shown in the FIG. 10, the anti-motion-sick module 140 determines whether the user wants to manually set the anti-motion-sick adjustment parameter DI1 and the anti-motion-sick method DI2. If the user wants to manually set the anti-motion-sick adjustment parameter DI1 and the anti-motion-sick method DI2, the process proceeds to step S133′. If the user does not want to manually set the anti-motion-sick adjustment parameter DI1 and the anti-motion-sick method DI2, the process proceeds to the step S133. In this step, a user interface may be provided to allow the user to select options such as “manual” or “automatic” to determine whether the user wants to manually set the anti-motion-sick adjustment parameter DI1 and the anti-motion-sick method DI2.

In the step S133, as shown in the FIG. 10, the parameter inference model 131 infers the anti-motion-sick adjustment parameter DI1 according to the user image RI1, and the method inference model 132 infers the anti-motion-Reference sick method DI2 according to the traffic information RI2 and the display information format RI3.

In this step, as shown in the FIG. 10, the parameter inference model 131 may first infer the user characteristic FT and the physiological state PS according to the user image RI1 and then infer the anti-motion-sick adjustment parameter DI1 according to the user characteristic FT and the physiological state PS. Alternatively, the parameter inference model 131 may directly infer the anti-motion-sick adjustment parameter DI1 according to the user image RI1.

In one embodiment, if the motion is high-frequency shaking, the motion compensation method of the display information IF in the FIG. 3A may be adopted. If the motion is side-to-side shaking, the motion compensation method of the dynamic U-tube UP in the FIG. 3C may be adopted. If the information coverage is small, the motion compensation method of the reference pattern PT in the FIG. 3B may be adopted. If the information coverage is large, the motion compensation method of the dynamic U-tube UP in the FIG. 3C may be adopted. In this embodiment, the method inference model 132 could comprehensively infer the appropriate anti-motion-sick method DI2 according to the traffic information RI2 and the display information format RI3. These embodiments are merely exemplary and do not limit the present disclosure.

In the step S133′, as shown in the FIG. 10, the anti-motion-sick module 140 obtains the anti-motion-sick adjustment parameter DI1′ and the anti-motion-sick method DI2′ manually set by the user.

Then, in the step S140, as shown in the FIG. 10, the anti-motion-sick module 140 controls the display unit 150 according to the anti-motion-sick display setting information DI, including the anti-motion-sick adjustment parameters DI1, DI1′ and the anti-motion-sick methods DI2, DI2′, to prevent or reduce the motion sickness occurred in the user traveling in a vehicle.

According to the embodiments illustrated in the FIGS. 10 and 11, the artificial intelligence technology could be used to adaptively infer the suitable anti-motion-sick adjustment parameters DI1 and the anti-motion-sick methods DI2 according to different user images RI1, different traffic conditions from traffic information RI2, and different display information formats RI3. This allows adaptive control of the display content of the display unit 150 to reduce or prevent motion sickness in the user.

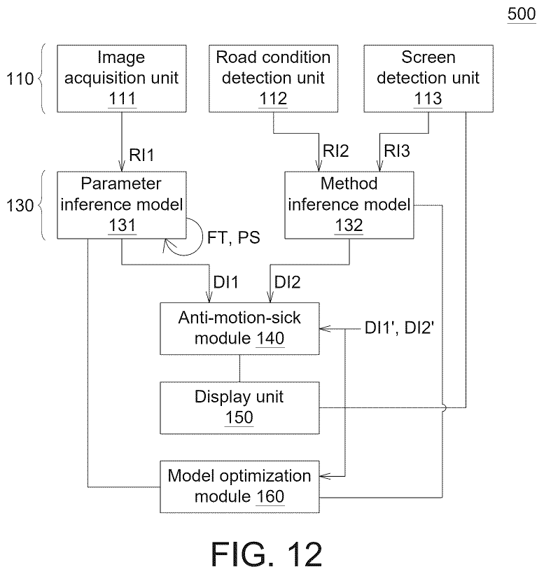

Please refer to FIG. 12, which illustrates a schematic diagram of an adaptive anti-motion-sick system 500 according to another embodiment of the present disclosure. In the adaptive anti-motion-sick system 500 shown in the FIG. 12, the real-time information acquisition module 110 includes, for example, the image acquisition unit 111, the road condition detection unit 112, and the screen detection unit 113. The inference module 130 includes the parameter inference model 131 and the method inference model 132. Additionally, the adaptive anti-motion-sick system 500 in the FIG. 12 further includes a model optimization module 160. The model optimization module 160 could be used for optimizing the model. The functions of the real-time information acquisition module 110, the inference module 130, the anti-motion-sick module 140, and the display unit 150 are as described above and will not be repeated here. The following sections, in conjunction with flowcharts, further explain the operation of each component.

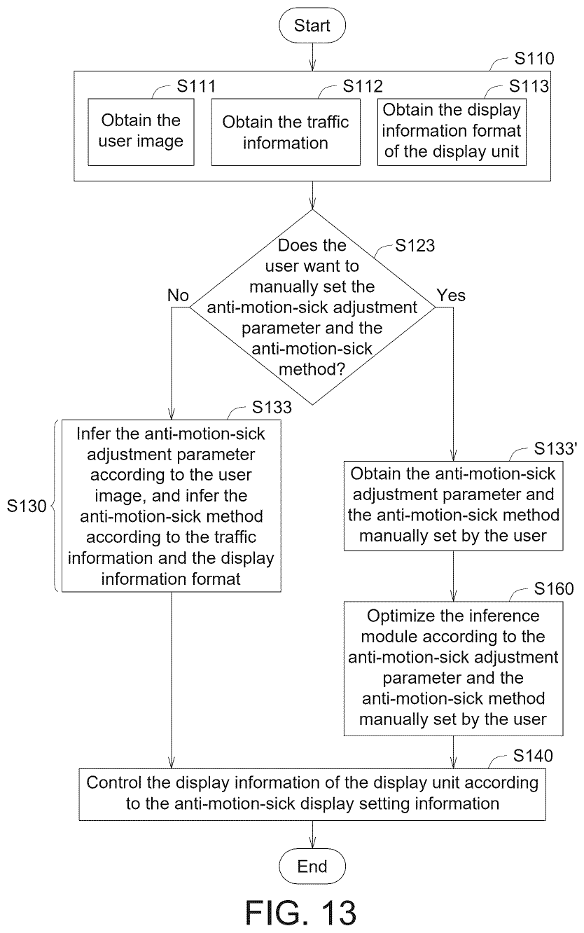

Please refer to FIG. 13, which illustrates a flowchart of an adaptive anti-motion-sick method according to another embodiment of the present disclosure. The adaptive anti-motion-sick method in FIG. 13 includes steps S110, S123, S130, S160, and S140. The step S110 includes steps S111, S112, and S113. The step S130 includes S133 and S133′.

In the step S111, as shown in the FIG. 12, the image acquisition unit 111 obtains a user image RI1. In the step S112, as shown in the FIG. 12, the road condition detection unit 112 obtains a traffic information RI2. In the step S113, as shown in the FIG. 12, the screen detection unit 113 obtains the display information format RI3 of the display unit 150. The steps S111 to S113, for example, may be executed simultaneously or in a predetermined sequence.

Next, in the step S123, as shown in the FIG. 12, the anti-motion-sick module 140 determines whether the user wants to manually set the anti-motion-sick adjustment parameter DI1 and the anti-motion-sick method DI2. If the user wants to manually set the anti-motion-sick adjustment parameter DI1 and the anti-motion-sick method DI2, the process proceeds to the step S133′; if the user does not want to manually set the anti-motion-sick adjustment parameter DI1 and the anti-motion-sick method DI2, the process proceeds to the step S133. In this step, for example, a user interface is provided for the user to select options such as “manual” and “automatic” to determine whether the user wants to manually set the anti-motion-sick adjustment parameter DI1 and the anti-motion-sick method DI2.

In the step S133, as shown in the FIG. 12, the parameter inference model 131 infers the anti-motion-sick adjustment parameter DI1 according to the user image RI1, and the method inference model 132 infers the anti-motion-sick method DI2 according to the traffic information RI2 and the display information format RI3.

In this step, as shown in the FIG. 10, the parameter inference model 131, for example, first infers the user characteristic FT and the physiological state PS according to the user image RI1 and then infers the anti-motion-sick adjustment parameter DI1 according to the user characteristic FT and the physiological state PS. Alternatively, the parameter inference model 131 may directly infer the anti-motion-sick adjustment parameter DI1 according to the user image RI1.

In one embodiment, if the shaking is high-frequency, the motion compensation method of the display information IF shown in the FIG. 3A may be used. If the shaking is left-right shaking, the motion compensation method of the dynamic U-tube UP shown in the FIG. 3C may be used. If the information occupies a smaller area, the motion compensation method of the reference pattern PT shown in the FIG. 3B may be used. If the information occupies a larger area, the motion compensation method of the dynamic U-tube UP shown in the FIG. 3C may be used. In this embodiment, the method inference model 132 could comprehensively infer a suitable anti-motion-sick method DI2 according to the traffic information RI2 and the display information format RI3. These embodiments are only for illustrative purposes, and the technology disclosed herein is not limited thereto.

In the step S133′, as shown in the FIG. 12, the anti-motion-sick module 140 obtains the anti-motion-sick adjustment parameter DI1′ and the anti-motion-sick method DI2′ manually set by the user.

Next, in the step S160, as shown in the FIG. 12, the model optimization module 160 optimizes the inference module 130 according to the anti-motion-sick adjustment parameter DI1′ and the anti-motion-sick method DI2′ manually set by the user. The model optimization module 160, for example, uses the anti-motion-sick adjustment parameter DI1′ and the anti-motion-sick method DI2′ manually set by the user as part of the training data to retrain the parameter inference model 131 and the method inference model 132 in the inference module 130, thereby improving the accuracy of the inference module 130.

Then, in the step S140, as shown in the FIG. 12, the anti-motion-File: sick module 140 controls the display unit 150 according to the anti-motion-sick adjustment parameters DI1 and DI1′ and the anti-motion-sick methods DI2 and DI2′ of the anti-motion-sick display setting information DI, to prevent or reduce the motion sickness occurred in users traveling in a vehicle.

According to the embodiments in the FIGS. 12 to 13, after the user manually sets the anti-motion-sick adjustment parameter DI1′ and the anti-motion-sick method DI2′, the model optimization module 160 could further optimize the inference module 130 to enhance the accuracy of the inference module 130.

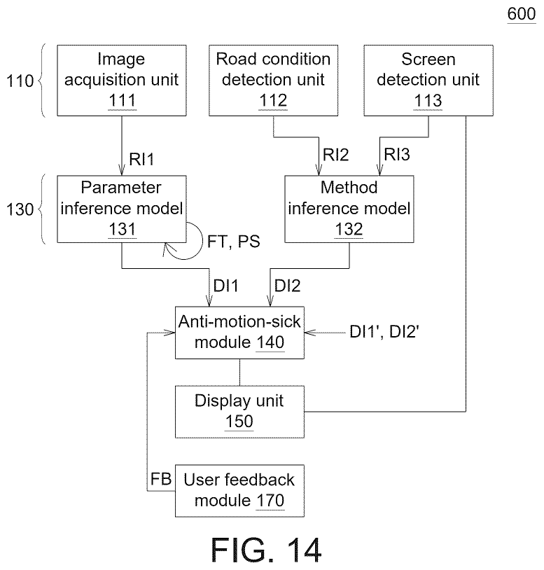

Please refer to FIG. 14, which illustrates a schematic diagram of an adaptive anti-motion-sick system 600 of another embodiment of the present disclosure. In the adaptive anti-motion-sick system 600 shown in the FIG. 14, the real-time information acquisition module 110 includes, for example, the image acquisition unit 111, the road condition detection unit 112, and the screen detection unit 113. The inference module 130 includes, for example, the parameter inference model 131 and the method inference model 132. In addition, the adaptive anti-motion-sick system 600 further includes a user feedback module 170. The user feedback module 170 is used to receive user feedback. The functions of the real-time information acquisition module 110, the inference module 130, the anti-motion-sick module 140, and the display unit 150 are as described above and will not be repeated here. The following section, along with a flowchart, further explains the operation of each component.

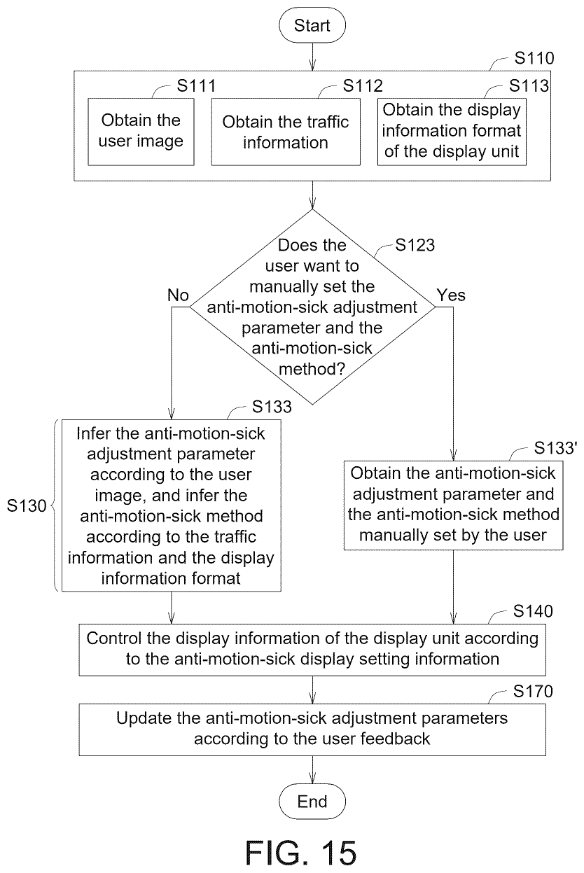

Please refer to FIG. 15, which illustrates a flowchart of an adaptive anti-motion-sick method according to another embodiment of the present disclosure. The adaptive anti-motion-sick method in the FIG. 15 includes steps S110, S123, S130, S140, and S170. The step S110 includes steps S111, S112, and S113. The step S130 includes steps S133 and S133′.

In the step S111, as shown in the FIG. 14, the image acquisition unit 111 obtains the user image RI1. In the step S112, as shown in the FIG. 14, the road condition detection unit 112 obtains the traffic information RI2. In the step S113, as shown in the FIG. 14, the screen detection unit 113 obtains the display information format RI3 of the display unit 150. The steps S111 to S113 may be performed simultaneously or in a predetermined sequence.

Next, in the step S123, as shown in the FIG. 14, the anti-motion-sick module 140 determines whether the user wants to manually set the anti-motion-sick adjustment parameter DI1 and the anti-motion-sick method DI2. If the user wants to manually set the anti-motion-sick adjustment parameter DI1 and the anti-motion-sick method DI2, the process proceeds to the step S133′; if the user does not want to manually set the anti-motion-sick adjustment parameter DI1 and the anti-motion-sick method DI2, the process proceeds to the step S133. In this step, a user interface is provided to allow the user to select options such as “manual” or “automatic” to determine whether the user wants to manually set the anti-motion-sick adjustment parameter DI1 and the anti-motion-sick method DI2.

In the step S133, as shown in the FIG. 14, the parameter inference model 131 infers the anti-motion-sick adjustment parameter DI1 according to the user image RI1, and the method inference model 132 infers the anti-motion-sick method DI2 according to the traffic information RI2 and the display information format RI3.

In this step, the parameter inference model 131 may first infer the user characteristic FT and the physiological state PS according to the user image RI1 and then infer the anti-motion-sick adjustment parameter DI1 according to the user characteristic FT and physiological state PS. Alternatively, the parameter inference model 131 may directly infer the anti-motion-sick adjustment parameter DI1 according to the user image RI1.

In one embodiment, if the motion is high-frequency shaking, the motion compensation method of the display information IF in the FIG. 3A may be used. If the motion is lateral shaking, the motion compensation method of the dynamic U-tube UP in the FIG. 3C may be used. If the information coverage is small, the motion compensation method of the reference pattern PT in the FIG. 3B may be used. If the information coverage is large, the motion compensation method of the dynamic U-tube UP in the FIG. 3C may be used. In this embodiment, the method inference model 132 may infer the appropriate anti-motion-sick method DI2 according to the traffic information RI2 and the display information format RI3 comprehensively. These embodiments are merely illustrative, and the disclosed technology is not limited thereto.

In the step S133′, as shown in the FIG. 14, the anti-motion-sick module 140 obtains the anti-motion-sick adjustment parameter DI1′ and the anti-motion-sick method DI2′ manually set by the user.

Next, in the step S140, as shown in the FIG. 14, the anti-motion-sick module 140 controls the display unit 150 according to the anti-motion-sick adjustment parameters DI1 and DI1′ of the anti-motion-sick display setting information DI and the anti-motion-sick methods DI2 and DI2′, to prevent or reduce the motion sickness occurred in the user traveling in the vehicle.

Then, in the step S170, as shown in the FIG. 14, the user feedback module 170 updates the anti-motion-sick adjustment parameters DI1 and DI1′ according to the user feedback FB. This step, for example, provides a user interface allowing the user to fine-tune the automatically inferred anti-motion-sick adjustment parameter DI1 or the manually set anti-motion-sick adjustment parameter DI1′ to achieve a more comfortable experience.

Through the embodiments shown in the FIGS. 14 to 15, if the user is not satisfied with the automatically inferred anti-motion-sick adjustment parameter DI1 or the manually set anti-motion-sick adjustment parameter DI1′, the user could adjust the anti-motion-sick adjustment parameters DI1 and DI1′ to provide a better comfort level.

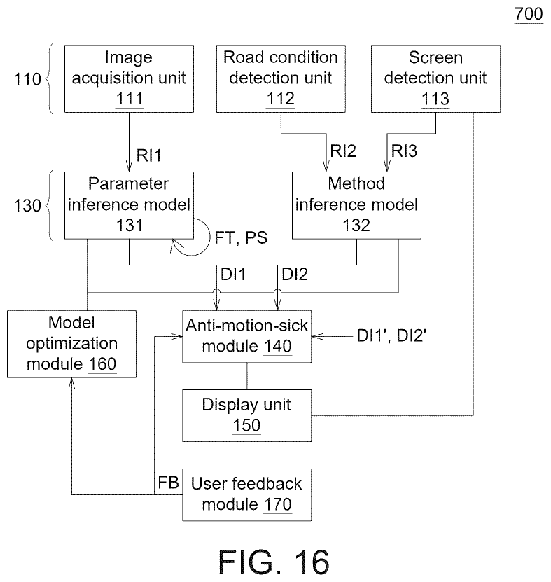

Please refer to FIG. 16, which illustrates a schematic diagram of an adaptive anti-motion-sick system 700 according to another embodiment of the present disclosure. In the adaptive anti-motion-sick system 700 shown in the FIG. 16, the real-time information acquisition module 110 includes, for example, the image acquisition unit 111, the road condition detection unit 112, and the screen detection unit 113. The inference module 130 includes, for example, the parameter inference model 131 and the method inference model 132. Additionally, the adaptive anti-motion-sick system 700 further includes a model optimization module 160 and a user feedback module 170. The operation of each component is further explained with the accompanying flowchart.

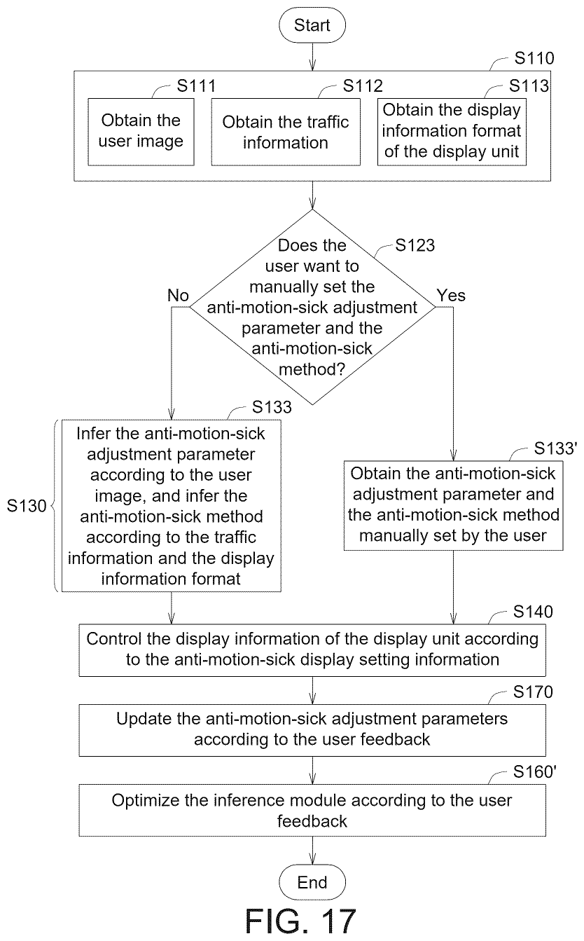

Please refer to FIG. 17, which illustrates a flowchart of an adaptive anti-motion-sick method according to another embodiment of the present disclosure. The adaptive anti-motion-sick method in the FIG. 17 includes steps S110, S123, S130, S140, S170, and S160′. The step S110 includes steps S111, S112, and S113. The step S130 includes steps S133 and S133′.

In the step S111, as shown in the FIG. 16, the image acquisition unit 111 obtains the user image RI1. In the step S112, as shown in the FIG. 16, the road condition detection unit 112 obtains the traffic information RI2. In the step S113, as shown in the FIG. 16, the screen detection unit 113 obtains the display information format RI3 from the display unit 150. The steps S111 to S113 may be executed simultaneously or in a predetermined sequence.

Next, in the step S123, as shown in the FIG. 16, the anti-motion-sick module 140 determines whether the user wants to manually set the anti-Reference motion-sick adjustment parameter DI1 and the anti-motion-sick method DI2. If the user wants to manually set the anti-motion-sick adjustment parameter DI1 and the anti-motion-sick method DI2, the process proceeds to the step S133′. If the user does not want to manually set the anti-motion-sick adjustment parameter DI1 and the anti-motion-sick method DI2, the process proceeds to the step S133. In this step, a user interface may be provided to allow the user to select options such as “manual” or “automatic” to determine whether the user wants to manually set the anti-motion-sick adjustment parameter DI1 and the anti-motion-sick method DI2.

In the step S133, as shown in the FIG. 16, the parameter inference model 131 infers the anti-motion-sick adjustment parameter DI1 according to the user image RI1, and the method inference model 132 infers the anti-motion-sick method DI2 according to the traffic information RI2 and the display information format RI3.

In this step, the parameter inference model 131, for example, may first infer the user characteristic FT and the physiological state PS according to the user image RI1, and then infer the anti-motion-sick adjustment parameter DI1 according to the user characteristic FT and the physiological state PS. Alternatively, the parameter inference model 131 may directly infer the anti-motion-sick adjustment parameter DI1 according to the user image RI1.

In one embodiment, if the motion is high-frequency shaking, the motion compensation method for the display information IF shown in the FIG. 3A may be used. If the motion is lateral shaking, the dynamic U-tube UP shown in the FIG. 3C may be used. If the display content occupies a small area, the reference pattern PT shown in the FIG. 3B may be used; if the display content occupies a large area, the dynamic U-tube UP shown in the FIG. 3C may be used. In this embodiment, the method inference model 132 may comprehensively infer the appropriate anti-motion-sick method DI2 according to the traffic information RI2 and the display information format RI3. These implementations are only illustrative, and the present disclosure is not limited thereto.

In the step S133′, as shown in the FIG. 16, the anti-motion-sick module 140 obtains the anti-motion-sick adjustment parameter DI1′ and the anti-motion-sick method DI2′ manually set by the user.

Next, in the step S140, as shown in the FIG. 16, the anti-motion-sick module 140 controls the display information of the display unit 150 according to the anti-motion-sick adjustment parameter DI1, DI1′ of the anti-motion-sick display setting information DI, and the anti-motion-sick method DI2, DI2′, to prevent or reduce motion sickness occurred in the user traveling in a vehicle.

Then, in the step S170, as shown in the FIG. 16, the user feedback module 170 updates the anti-motion-sick adjustment parameter DI1 and DI1′ according to the user feedback FB. This step may provide a user interface, allowing the user to fine-tune the automatically inferred anti-motion-sick adjustment parameter DI1 or the manually set anti-motion-sick adjustment parameter DI1′ to achieve a more comfortable experience.

Next, in the step S160′, the model optimization module 160 optimizes the inference module 130 according to the user feedback FB. For example, the model optimization module 160 may update the weight of training data according to the user feedback FB and retrain the parameter inference model 131 to improve the accuracy of the inference module 130.

According to the embodiments shown in the FIGS. 16 to 17, the user could adjust the anti-motion-sick adjustment parameter DI1 and DI1′ to provide a more comfortable experience. The model optimization module 160 could also further optimize the inference module 130 according to the user feedback FB to improve its accuracy.

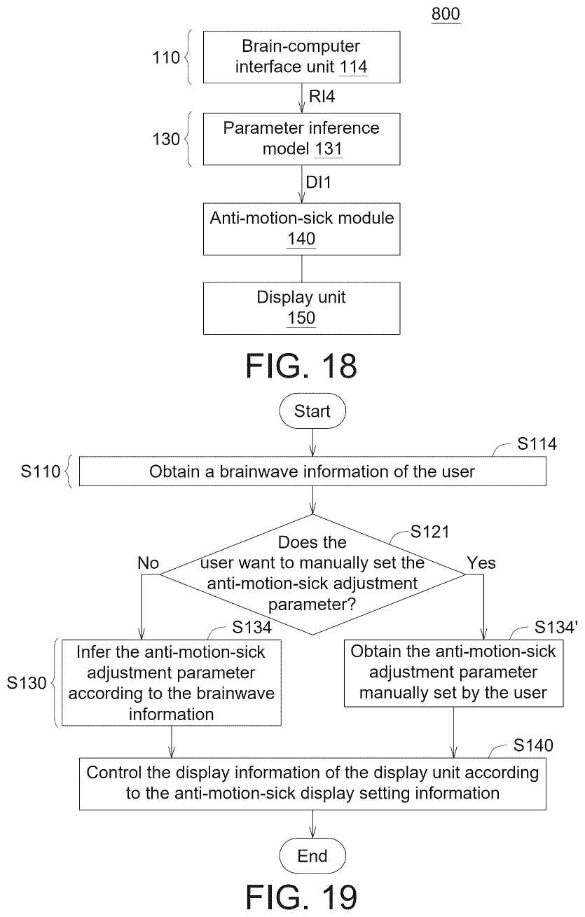

Please refer to FIG. 18, which illustrates a schematic diagram of an adaptive anti-motion-sick system 800 of another embodiment of the present disclosure. In the adaptive anti-motion-sick system 800, the real-time information acquisition module 110 includes, for example, the brain-computer interface unit 114. The inference module 130 includes, for example, the parameter inference model 131. The brain-computer interface unit 114 could be used to obtain the brainwave information of the user. The functions of the anti-motion-sick module 140 and the display unit 150 are as described above and will not be repeated here. The following will explain the operation of each component in detail with reference to the flowchart.

Please refer to FIG. 19, which illustrates a flowchart of the adaptive anti-motion-sick method according to another embodiment of the present disclosure. The adaptive anti-motion-sick method shown in the FIG. 19 includes steps S110, S121, S130, and S140. The step S110 includes step S114. The step S130 includes steps S134 and S134′.

In the step S114, as shown in the FIG. 18, the brain-computer interface unit 114 obtains a brainwave information RI4 of the user. The brain-computer interface unit 114, for example, may include an analyzer and multiple electrode pads. The electrode pads may be installed inside devices such as headphones, helmets, or glasses.

Next, in the step S121, as shown in the FIG. 18, the anti-motion-sick module 140 determines whether the user wants to manually set the anti-motion-sick adjustment parameter DI1. If the user wants to manually set the anti-motion-sick adjustment parameter DI1, the process proceeds to the step S134′; if the user does not want to manually set the anti-motion-sick adjustment parameter DI1, the process proceeds to the step S134. In this step, for example, a user interface may be provided, allowing the user to select options such as “manual” and “automatic” to determine whether the user wants to manually set the anti-motion-sick adjustment parameter DI1.

Then, in the step S134, as shown in the FIG. 18, the parameter inference model 131 infers the anti-motion-sick adjustment parameter DI1 according to the brainwave information RI4. When the brain's visual perception does not match the motion, it affects the user's sense of balance. When the brain attempts to balance visual perception with motion, brainwaves may be generated. The parameter inference model 131 could infer a suitable anti-motion-sick adjustment parameter DI1 according to the brainwave information RI4.

In the step S134′, as shown in the FIG. 18, the anti-motion-sick module 140 obtains the anti-motion-sick adjustment parameter DI1′ manually set by the user.

Next, in the step S140, as shown in the FIG. 18, the anti-motion-sick module 140 controls the display unit 150 according to the anti-motion-sick adjustment parameters DI1 and DI1′ of the anti-motion-sick display setting information DI, to prevent or reduce the motion sickness occurred in the user traveling in a vehicle.

According to the embodiments shown in the FIGS. 18 and 19, based on the different variations of the brainwave information RI4 of the user, the artificial intelligence technology could be used to adaptively infer a suitable anti-motion-sick adjustment parameter DI1. This enables the adaptive control of the display content of the display unit 150 to reduce or prevent the motion sickness occurred in the user.

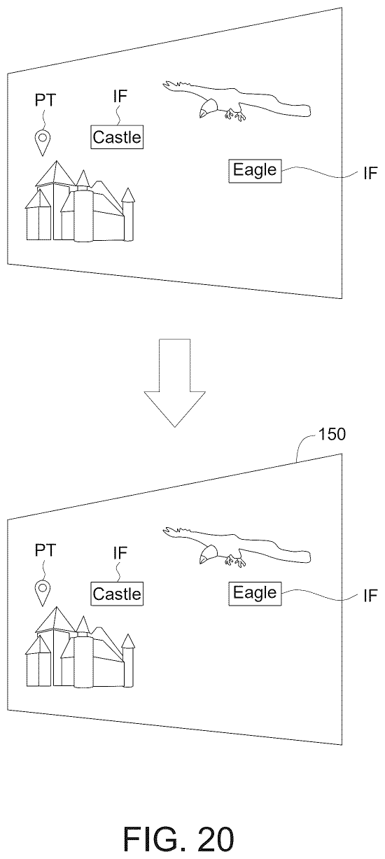

Please refer to FIG. 20, which illustrates a display method of the display information IF and the reference pattern PT according to an embodiment of the present disclosure. In another embodiment, the anti-motion-sick module 140 may adjust the display of the display information IF or the reference pattern PT according to the gaze intersection points, the movement direction of the objects, the movement speed, etc., for example, by keeping them aligned on the same horizontal line. This helps prevent excessive complexity in the screen of the display unit 150 and avoids overlapping of the display information IF and the reference pattern PT.

Through the above embodiments, the inference module 130 could utilize the artificial intelligence technology to infer the anti-motion-sick adjustment parameters DI1 and the anti-motion-sick method DI2 according to the real-time information RI, the including user image RI1, the traffic information RI2, the display information format RI3, and the brainwave information RI4. This helps prevent or reduce motion sickness occurred in the users traveling in a vehicle.

It will be apparent to those skilled in the art that various modifications and variations could be made to the disclosed embodiments. It is intended that the specification and examples be considered as exemplars only, with a true scope of the disclosure being indicated by the following claims and their equivalents.

What is claimed is:

1. An adaptive anti-motion-sick method, comprising:
obtaining a real-time information, wherein the real-time information is a user image of a user, a traffic information, a display information format of a display unit, or a combination thereof;
inferring, by an inference module, an anti-motion-sick display setting information according to the real-time information, wherein the anti-motion-sick display setting information is an anti-motion-sick adjustment parameter, an anti-motion-sick method, or a combination thereof; and
controlling the display unit according to the anti-motion-sick display setting information.

2. The adaptive anti-motion-sick method according to claim 1, wherein the anti-motion-sick adjustment parameter is color, X-axis compensation amplitude, Y-axis compensation amplitude, Z-axis compensation amplitude, or a combination thereof.

3. The adaptive anti-motion-sick method according to claim 1, wherein the anti-motion-sick method is dynamically compensating a display information or displaying a dynamic U-tube.

4. The adaptive anti-motion-sick method according to claim 1, wherein the display information format of the display unit is an information screen occupancy.

5. The adaptive anti-motion-sick method according to claim 1, wherein a parameter inference model of the inference module infers the anti-motion-sick adjustment parameter according to the user image, and a method inference model of the inference module infers the anti-motion-sick method according to the traffic information and the display information format.

6. The adaptive anti-motion-sick method according to claim 1, further comprising:
optimizing the inference module according to the anti-motion-sick adjustment parameter and the anti-motion-sick method manually set by the user.

7. The adaptive anti-motion-sick method according to claim 1, further comprising:
updating the anti-motion-sick adjustment parameter according to the feedback from the user.

8. The adaptive anti-motion-sick method according to claim 1, further comprising:
updating the anti-motion-sick adjustment parameter according to the feedback from the user; and
optimizing the inference module according to the feedback from the user.

9. The adaptive anti-motion-sick method according to claim 1, wherein the real-time information comprises a brainwave information.

10. The adaptive anti-motion-sick method according to claim 1, wherein the anti-motion-sick method comprises compensating a display information or displaying a reference pattern, wherein the display information or the reference pattern remains on a horizontal line.

11. An adaptive anti-motion-sick system, comprising:
a display unit;
a real-time information acquisition module, for obtaining a real-time information, wherein the real-time information comprises a user image of a user, a traffic information, a display information format of the display unit, or a combination thereof;
an inference module, for inferring an anti-motion-sick display setting information according to the real-time information, wherein the anti-motion-sick display setting information comprises an anti-motion-sick adjustment parameter, an anti-motion-sick method, or a combination thereof; and
an anti-motion-sick module, for controlling the display unit according to the anti-motion-sick display setting information.

12. The adaptive anti-motion-sick system according to claim 11, wherein the inference module comprises:
a parameter inference model, for inferring the anti-motion-sick adjustment parameter, wherein the anti-motion-sick adjustment parameter comprises color, X-axis compensation amplitude, Y-axis compensation amplitude, Z-axis compensation amplitude, or a combination thereof.

13. The adaptive anti-motion-sick system according to claim 11, wherein the inference module comprises:
a method inference model, for inferring the anti-motion-sick method, wherein the anti-motion-sick method comprises dynamically compensating a display information or displaying a dynamic U-tube.

14. The adaptive anti-motion-sick system according to claim 11, wherein the real-time information acquisition module comprises:
a screen detection unit, for detecting the display information format of the display unit, wherein the display information format of the display unit comprises an information screen occupancy.

15. The adaptive anti-motion-sick system according to claim 11, wherein the inference module comprises:
a parameter inference model, for inferring the anti-motion-sick adjustment parameter according to the user image; and
a method inference model, for inferring the anti-motion-sick method according to the traffic information and the display information format input.

16. The adaptive anti-motion-sick system according to claim 11, further comprising:
a model optimization module, for optimizing the inference module according to the anti-motion-sick adjustment parameter and the anti-motion-sick method manually set by the user.

17. The adaptive anti-motion-sick system according to claim 11, further comprising:
a user feedback module, for updating the anti-motion-sick adjustment parameter according to the feedback from the user.

18. The adaptive anti-motion-sick system according to claim 11, further comprising:
a user feedback module, for updating the anti-motion-sick adjustment parameter according to the feedback from the user; and
a model optimization module, for optimizing the inference module according to the feedback from the user.

19. The adaptive anti-motion-sick system according to claim 11, wherein the real-time information acquisition module comprises:
a brain-computer interface unit, for obtaining a brainwave information of the user, wherein the inference module further infers the anti-motion-sick adjustment parameter according to the brainwave information.

20. The adaptive anti-motion-sick system according to claim 11, wherein the anti-motion-sick method comprises compensating a display information or displaying a reference pattern, wherein the display information or the reference pattern remains on a horizontal line.
